(19) United States
(12) Patent Application Publication
(10) Pub. No.: US 2011/0140656 A1
(43) Pub. Date: Jun. 16, 2011

(54) CHARGING STATION WITH PROTECTIVE DOOR

(76) Inventors: Gary Starr, Santa Rosa, CA (US); Bao Tran, Saratoga, CA (US)

(21) Appl. No.: 12/728,236

(22) Filed: Mar. 21, 2010

Related U.S. Application Data
(60) Provisional application No. 61/174,336, filed on Apr. 30, 2009.
(60) Provisional application No. 61/295,048, filed on Jan. 14, 2010.

(51) Int. Cl. H02J 7/00

(52) U.S. Cl. 320/109

(57) ABSTRACT

An electric vehicle charging station includes a parking meter; a main display coupled to the parking meter to display information; a fast charge port and a regular charge port coupled to the parking meter to dispense electricity upon authorization; a payment reader coupled to the parking meter to accept a financial card and to enable one or more ports after card authorization; a door coupled to the charge ports, the door allowing access to the ports after authorization and closing access to the ports after charging completes, the door securing the port from unauthorized charging and to secure the ports from tampering; and an outer casing to enclose the parking meter.

This application claims priority to U.S. Application Ser. No. 61/174,336, filed Apr. 30, 2009, and 61/295,048 filed Jan. 14, 2010, the contents of which are incorporated by reference.

### BACKGROUND

The present invention relates to rapid recharging circuits and recharging stations for electric vehicles.

Battery electric vehicles has been developed more than a century ago, yet the usage of plug-in battery electric vehicles is still limited to some short distance, low speed transportation such as golf carts, commuting carts in big buildings and manufacturing facilities and handicap vehicles. Although many different models of electric cars have been developed, none of them have achieved the market acceptance of vehicles powered by internal combustion engines.

However, recent awareness of human activity's impacts on environment pollution has propelled the need to develop green vehicle alternatives to gasoline powered vehicles such as electric vehicles. At present trend, there will be 2.5 billion vehicles on the planet by 2050, up from 600 million this year. The continued economic development of India, China and Brazil will lead to a staggering increase in the number of vehicles on the world's roads. Thus, electrification of short-haul transportation becomes the only viable alternative.

One issue with electric vehicles is the battery capacity/weight. At current, most electric cars offer a range of 50-60 miles before they need to be recharged. However, most garages or parking meters do not offer power plugs to recharge these cars.

U.S. Pat. No. 4,532,418 discloses a structure for charging an electric vehicle at a parking location and facilitating billing for the charging energy utilized and the parking time. The structure includes a charging and parking meter at a parking space for receiving a charge card and into which a charging plug from an electric vehicle may be placed, structure for reading the charge card placed in the meter and for locking the plug in place, and a central processor unit for determining the charging energy used and parking time and for storing billing data relative thereto at a remote location, for periodic removal to facilitate billing. The parking meter permits charging of an electric vehicle at a parking location in response to use of a charge card and stores charging and parking information for subsequent retrieval to facilitate billing to the owner of the charge card.

### SUMMARY

In one aspect, an electric vehicle charging station includes a parking meter; a main display coupled to the parking meter to display information; a fast charge port and a regular charge port coupled to the parking meter to dispense electricity upon authorization; a payment reader coupled to the parking meter to accept a financial card and to enable one or more ports after card authorization; a door coupled to the charge ports, the door allowing access to the ports after authorization and closing access to the ports after charging completes, the door securing the port from unauthorized charging and to secure the ports from tampering; and an outer casing to enclose the parking meter.

Implementations of the vehicle may include one or more of the following. The charger provides both fast and slow charging in public and private locations. The charger is capable of recharging a plurality of vehicles such as five vehicles simultaneously with full reporting of power consumed and duration of charge cycle. All size electric vehicles from bikes to industrial vehicles to scooters, cars, trucks, and buses. Also any electronic device or gadget could receive a charge.

The charger is fully weatherized and certified under UL291 for outdoor use. The charger also includes SAE J1772 Connectivity. The charger has an embedded utility grade electronic meter. The meter provides an ability to precisely measure and report electricity use. Such meter enables a sustainable, flexible business model that meets the needs of drivers, corporations, fleet operators, utility companies and municipalities.

Payment for the charge can be received through various payment mechanisms including smart card, credit card, change, paper money, code through a key card, biometric thumb print, among others. The charger station can be used by anyone who possesses any of the above and a manual entered pin code if a smart card is utilized. The payment can be made through a revenue generating business model that includes flexible subscriber payment methods such as “free” charging, pay per use, by subscription, and by kWh (where allowed). The payment can be validated by various members such as specific chain stores that contribute or provide free charging for the advertising and PR benefit. A pay point system can be provided where pre-paid cards may be issued by the owner or by independent vendors upon receipt of payment. The station could also provide advertising through a computer screen or wall space, also providing a means of producing income. Large chain stores such as McDonalds, Starbucks, Costco, Best Buy and the like can receive large advertising benefits from advertising on and having charge stations located in their facilities.

Once the user is recognized, the charger has an on light and automatic door opening system that activates the power to the plug. Metering of power consumption is via internal smart metering system that update remotely via the mobile phone network. The metered power can by viewed online by users/members of the system and site owner. The rate can be adjusted remotely and by time of day. The rates payable per kilowatt hour (KWH) can be viewed online. During recharge an on screen display shows how much KWH is being drawn.

The system has an anti-power piracy and security circuit in one embodiment. A sensor detects if the power cable has been cut, and power ceases. A text message is sent to the user/owner to inform there has been a power interruption. A tamper alarm will sound if security of system is violated. A resettable GFI is incorporated to allow the system to recover from power surges. When current drops to near zero a text message is sent to the owner, noting the vehicle has reached full charge.

A smart controller is provided to optimize the charging schedule to minimize cost, enhance grid stability, and to safely set the maximum battery charge rate within the electrical limits of the battery, battery charger, and premises/charging station. The charger operates in a way that utilities would prefer to have it, and EV owners would prefer to have it. The smart charger controller communicates with the battery charger, charging station/premises, display, and the battery management system to set and control when and how the vehicle's battery will be charged. Utilities can target demand and respond to event to specific areas as needed.

The Smart Charger Controller implements communications through RS-232, SPI, I2C, ZigBee, and CAN 2.0 methods. The J-1772 standard assigns connector pins for vehicle to charging station/premises communication. The Smart Charger Controller design incorporates the capability to communicate using this capability. The communication interfaces include:

1. Premises/Charging Station: ZigBee and RS-232. Capability available for USB, Ethernet, and 802.11. Communicates electrical capabilities, price schedules, vehicle ID/payment authorization.

2. Battery Charger: currently CAN-bus. Capability available for USB, RS-232, RS-485, Ethernet, 802.11, and PWM. Communicates the battery charger status, battery status, and allowable charge rate information.

3. Battery Management System: currently CAN-bus. Capability available for USB, RS-232, RS-485, Ethernet, and 802.11. Communicates charging related information appropriate to the installed battery type.

4) Grid Friendly Module and External Memory: I2C or SPI. Internal communication only.

5) Display/Operator Interface: I2C, SPI, RS-485, CAN, ZigBee. Communicates owner preferences, vehicle ID/payment authorization, etc.

In one embodiment, the charging station receives power from the utility grid. In another embodiment, the charging station receives solar energy and converts solar energy into electricity. In yet another embodiment, combinations of solar charging and utility grid charging can be used.

In one embodiment, an application running on a car computer or a cell phone can locate nearest charge station via google maps or by a car GPS, among others.

In one embodiment, dependent on the location, the charging station can dispense cash and provide ATM functionality. This embodiment has all the benefits of an ATM machine and can deposit checks, withdraw limited funds. Including display, keyboard, Dip-Style card reader, dispenser, receipt printer, communication system, and security UL291 Level 1 listed vault.

The charging station can take a number of forms. In one embodiment, the charger can be an electronic parking meter. In another embodiment, the parking meter can issue a prepaid parking slip. Electronic Parking meters are receiving wider use due to their ability to increase revenues to a city or parking lot owner. By incorporating this feature the additional cost of incorporating a charging feature is minimal. In one embodiment, the system includes an illuminated display, receipt printer.

In addition to brand new charging stations, existing structures can be converted into charging stations to save money. For example, existing phone booths could be converted into charge stations. Many are located in areas where there is parking, are often located close to curbs, and they already have built-in electricity supplies and a phone wire connection. Furthermore the permit process for a standalone commercial pay device already has the necessary governmental permits and approvals needed. As a result, its cheaper to convert the booths into charging stations than to build the stations from scratch. Now with the proliferation of cell phones, many are just wasting space. The phone booth's conversion to a multi-use charge station enables the booth to become useful and income producing. Similarly, in the USA and other localities, emergency phone stations have been installed. These could be adapted to be emergency charge stations. Additionally, street lights can be converted into charging stations. Street lights have power available and with suitable minor conversions can become charging stations.

Moreover, rest stops along the highway have phone, power source, and parking and can be converted into charge stations. Other structures such as tourist information kiosks can be converted. These units often located at rest stops or a local chamber of commerce can provide another location that can be adapted as charge stations.

The power cable can be a coaxial cable or a power cable and a data cable. The data cable can be a fiber optic cable. The data cable can also be an Ethernet cable. The data can be an Internet Protocol (IP) in the cable. Each body panel can have a battery recharger. The body panel can be made of lithium ion batteries. The batteries can have a shape that conforms to a specific shape such as a door or a hood or a seat, for example. To protect the occupant, a beam can be used that transfers a crash load into the vehicle body and away from a passenger cabin. Additionally, driver and passenger air bags positioned in the vehicle body. A wireless transceiver can be connected to the power cable. The wireless transceiver sends status of components in the vehicle to a remote computer. The wireless transceiver communicates maintenance information to a remote computer. If needed, the remote computer orders a repair part based on the maintenance information and schedules a visit to a repair facility to install the repair part.

Advantages of the preferred embodiment may include one or more of the following. The system distributes recharging energy so replenishing the battery can be done quickly and in a distributed manner. Cost is minimized since overhead charging control components are centralized in a controller. The actual energy transfer switches are distributed to minimize energy losses. The system is light weight and distributes the weight of the battery throughout the car. The battery can be air cooled since it is not densely packed into a large brick. Battery repair and replacement can be done easily as well. The strength of the battery is available as structural support to provide safety to the occupant of the vehicle.

The system enables widespread adoption of charging outlets or charging stations. In order for them to be widespread, the system is cost effective to install in the hundreds of thousands worldwide. In order for them to be cost effective the system is multipurpose, and multi-use. The system allows the consumer and utility company to be able to control when the charging stations are being used. In order to be user friendly, they must be able to paid for through various means.

### BRIEF DESCRIPTION OF THE DRAWINGS

FIG. 1A shows an exemplary front view of a charging station.

FIG. 1B shows an exemplary front perspective view of the charging station of FIG. 1A.

FIG. 1C shows an exemplary rear view of the charging station.

FIG. 1D shows another exemplary parking meter.

FIG. 2 illustrates an exemplary battery system and an exemplary power cable system for a car.

FIG. 3 shows an exemplary car electronic system.

FIG. 4 illustrates an exemplary battery system and an exemplary power cable system for a car.

### DESCRIPTION

Methods and apparatus that implement the embodiments of the various features of the disclosure will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

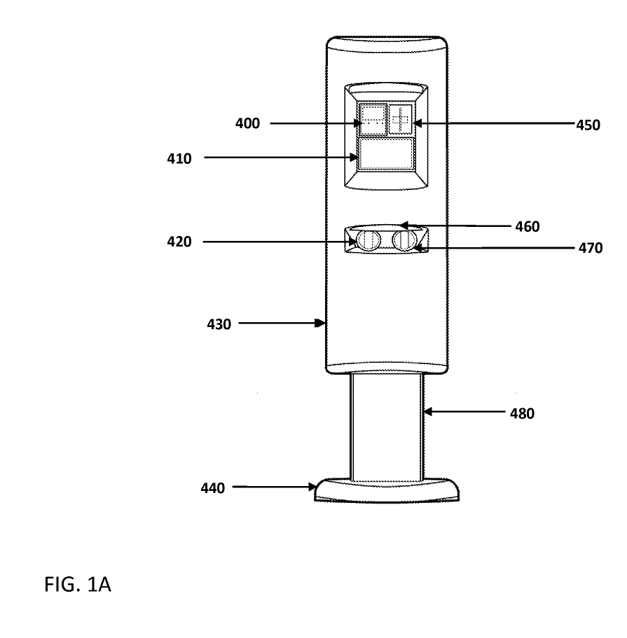

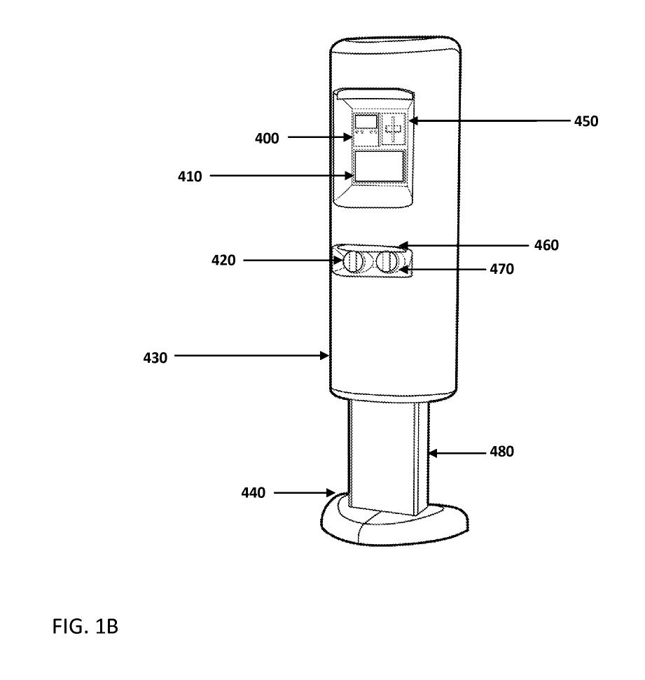

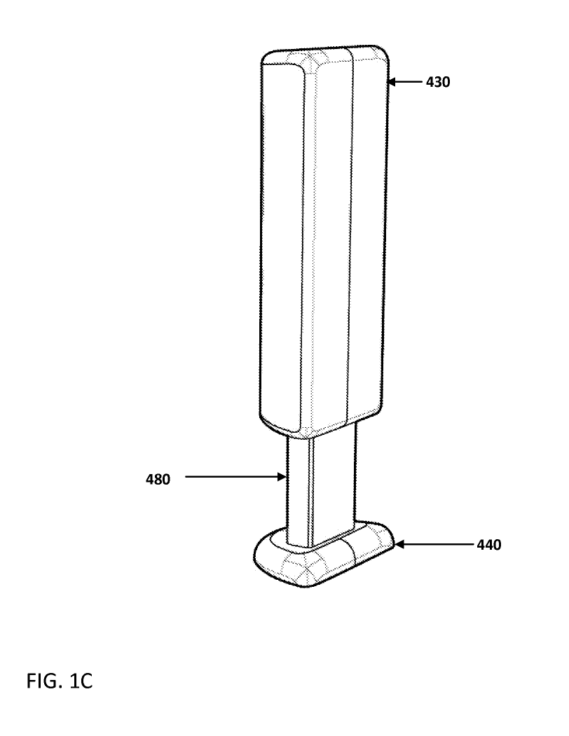

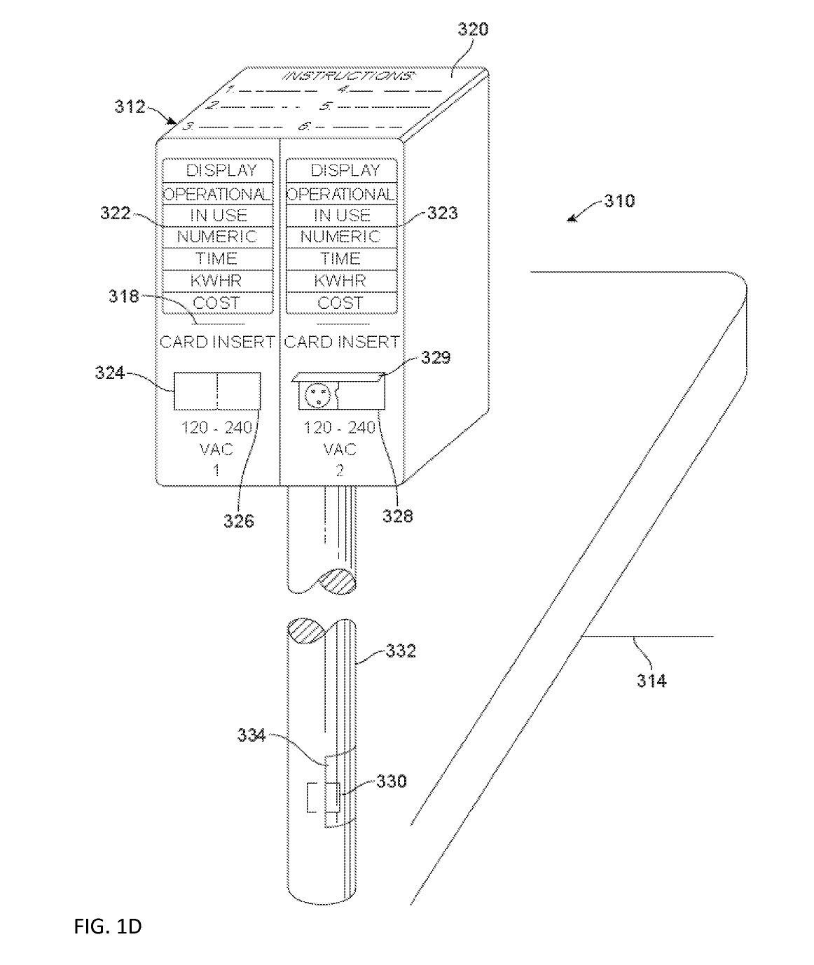

FIG. 1A shows an exemplary front view of a charging station. FIG. 1B shows an exemplary front perspective view of the charging station of FIG. 1A. FIG. 1C shows an exemplary rear view of the charging station.

Viewing FIGS. 1A-1C in combination, the charging station includes a dual fast charge port (item 420 and 470), via a pre-paid metering system 400 such as a Holley pre-paid meter. In this embodiment, the system is activated by inserting a prepaid card into the card reader 450. The Holley pre-paid meter 400 powers on and displays pre-paid card data. A main display screen 410 displays information as well as advertisements. The screen 410 can be used as a functional touch screen to select pre-paid meter options. After the chosen options are selected the dual port door 460 opens. This dual port door 460 is used secure the port from unauthorized users and secure the plug from tampering after activated. A standard 110V Port 420 is used for standard charging rate using 110V power. Fast charge Port 470 is used for fast charging at a high voltage such as 220V+. An outer casing 430 of the Charging Station securely encloses all component hardware within the unit. The outer casing 430 is placed on a solid steel mounting base 480 that is fixed to a selected location. A mounting base cover 440 is used to cover the mounting bolts to the fixed location.

The charger provides both fast and slow charging in public and private locations. The charger is capable of recharging a plurality of vehicles such as five vehicles simultaneously with full reporting of power consumed and duration of charge cycle. All size electric vehicles from bikes to industrial vehicles to scooters, cars, trucks, and buses. Also any electronic device or gadget could receive a charge.

The charger is fully weatherized and certified under UL291 for outdoor use. The charger also includes SAE J1772 Connectivity. The charger has an embedded utility grade electronic meter. The meter provides an ability to precisely measure and report electricity use. Such meter enables a sustainable, flexible business model that meets the needs of drivers, corporations, fleet operators, utility companies and municipalities.

Payment for the charge can be received through various payment mechanisms including smart card, credit card, change, paper money, code through a key card, biometric thumb print, among others. The charger station can be used by anyone who possesses any of the above and a manual entered pin code if a smart card is utilized. The payment can be made through a revenue generating business model that includes flexible subscriber payment methods such as “free” charging, pay per use, by subscription, and by kWh (where allowed). The payment can be validated by various members such as specific chain stores that contribute or provide free charging for the advertising and PR benefit. A pay point system can be provided where pre-paid cards may be issued by the owner or by independent vendors upon receipt of payment. The station could also provide advertising through a computer screen or wall space, also providing a means of producing income. Large chain stores such as McDonalds, Starbucks, Costco, Best Buy and the like can receive large advertising benefits from advertising on and having charge stations located in their facilities.

Once the user is recognized, the charger has an on light and automatic door opening system that activates the power to the plug. Metering of power consumption is via internal smart metering system that update remotely via the mobile phone network. The metered power can by viewed online by users/members of the system and site owner. The rate can be adjusted remotely and by time of day. The rates payable per kilowatt hour (KWH) can be viewed online. During recharge an on screen display shows how much KWH is being drawn.

The system has an anti-power piracy and security circuit in one embodiment. A sensor detects if the power cable has been cut, and power ceases. A text message is sent to the user/owner to inform there has been a power interruption. A tamper alarm will sound if security of system is violated. A resettable GFI is incorporated to allow the system to recover from power surges. When current drops to near zero a text message is sent to the owner, noting the vehicle has reached full charge.

A smart controller is provided to optimize the charging schedule to minimize cost, enhance grid stability, and to safely set the maximum battery charge rate within the electrical limits of the battery, battery charger, and premises/charging station. The charger operates in a way that utilities would prefer to have it, and EV owners would prefer to have it. The smart charger controller communicates with the battery charger, charging station/premises, display, and the battery management system to set and control when and how the vehicle's battery will be charged. Utilities can target demand and respond to event to specific areas as needed.

The Smart Charger Controller implements communications through RS-232, SPI, I2C, ZigBee, and CAN 2.0 methods. The J-1772 standard assigns connector pins for vehicle to charging station/premises communication. The Smart Charger Controller design incorporates the capability to communicate using this capability. The communication interfaces include:

1. Premises/Charging Station: ZigBee and RS-232. Capability available for USB, Ethernet, and 802.11. Communicates electrical capabilities, price schedules, vehicle ID/payment authorization.

2. Battery Charger: currently CAN-bus. Capability available for USB, RS-232, RS-485, Ethernet, 802.11, and PWM. Communicates the battery charger status, battery status, and allowable charge rate information.

3. Battery Management System: currently CAN-bus. Capability available for USB, RS-232, RS-485, Ethernet, and 802.11. Communicates charging related information appropriate to the installed battery type.

4) Grid Friendly Module and External Memory: I2C or SPI. Internal communication only.

5) Display/Operator Interface: I2C, SPI, RS-485, CAN, ZigBee. Communicates owner preferences, vehicle ID/payment authorization, etc.

In one embodiment, the charging station receives power from the utility grid. In another embodiment, the charging station receives solar energy and converts solar energy into electricity. In yet another embodiment, combinations of solar charging and utility grid charging can be used.

In one embodiment, an application running on a car computer or a cell phone can locate nearest charge station via google maps or by a car GPS, among others.

In one embodiment, dependent on the location, the charging station can dispense cash and provide ATM functionality. This embodiment has all the benefits of an ATM machine and can deposit checks, withdraw limited funds. Including display, keyboard, Dip-Style card reader, dispenser, receipt printer, communication system, and security UL291 Level 1 listed vault.

The charging station can take a number of forms. In one embodiment, the charger can be an electronic parking meter. In another embodiment, the parking meter can issue a prepaid parking slip. Electronic Parking meters are receiving wider use due to their ability to increase revenues to a city or parking lot owner. By incorporating this feature the additional cost of incorporating a charging feature is minimal. In one embodiment, the system includes an illuminated display, receipt printer.

In addition to brand new charging stations, existing structures can be converted into charging stations to save money. For example, existing phone booths could be converted into charge stations. Many are located in areas where there is parking, are often located close to curbs, and they already have built-in electricity supplies and a phone wire connection. Furthermore the permit process for a standalone commercial pay device already has the necessary governmental permits and approvals needed. As a result, its cheaper to convert the booths into charging stations than to build the stations from scratch. Now with the proliferation of cell phones, many are just wasting space. The phone booth's conversion to a multi-use charge station enables the booth to become useful and income producing. Similarly, in the USA and other localities, emergency phone stations have been installed. These could be adapted to be emergency charge stations. Additionally, street lights can be converted into charging stations. Street lights have power available and with suitable minor conversions can become charging stations.

Moreover, rest stops along the highway have phone, power source, and parking and can be converted into charge stations. Other structures such as tourist information kiosks can be converted. These units often located at rest stops or a local chamber of commerce can provide another location that can be adapted as charge stations.

FIG. 1D shows an exemplary charging station formulated as a parking meter. In one embodiment, the electric vehicle charging and parking meter system includes a meter 312 positioned adjacent a parking space 314 and a microprocessor (not shown) connected to the meter 312 for computing and storing time, electrical energy use and cost data for vehicles parked in the parking space 314. The microprocessor stores time, kilowatt hour and cost data for transmission to a central billing computer determine and collect fees from the car owner who used the meter 312.

In use, a series of charging and parking meters 312 are placed at a location along a street or a parking facility and supplying alternating current, as for example, 120 or 240 volt A.C., thereto. In one embodiment, the electric vehicles have distributed chargers, one for each group of batteries, for converting the alternating current energy available at the meter structures 312 to direct current and for controlling the state of charge of the vehicle batteries. The distributed chargers enable each group of batteries to be charged separately, thus avoiding the bottleneck of one set of battery slowing down the charging of another set. Also, power can be provided in parallel rather then sequentially.

Preferably, a wireless control device in the car transmits financial information to the meter 312 to enable power to be provided to the charging cord plug to the meter 312. In one embodiment, the wireless control device can be a cell phone communicating with the meter 312 using Bluetooth, ZigBee (802.15) or WiFi (802.11). Alternatively, to facilitate use by one time users who do not have an account, the charging can be facilitated by inserting a charge card into the meter 312, through slot 318, and connecting the electric vehicle's charging cord plug to the meter 312.

A plurality of voltage sources, for example, 120 and 240 volt A.C. outlets 24 and 26, respectively, can be provided at the meter 312. The voltage sources 324 and 326 are provided with a sliding cover 328 so that only one will be available at any one time, and are further provided with a separate spring loaded cover 329 to protect the voltage sources when not in use. A ground fault interrupter breaker 30 is provided in the meter post 332 with access through the post door 334.

The meter 312 includes a display 322 or 323 to provide user feedback. The display 322 or 323 can be a touch screen display to capture user input as well. The meter structure 312 includes the separate operational display structure 322 and numeric display structure 323, also includes the plug lock mechanism 338 and card reader 340. The plug lock mechanism 338 is operable on an instruction from the wireless transceiver on the vehicle or on the first insertion of a charge card to lock a vehicle's electric charging cord plug to the meter structure 312 and to release the plug from the meter structure 312 on the second insertion of a charge card in the meter 310. The card reader 340 functions to identify the presence of a card in the meter 310 and to validate the card in accordance with identification parameters on the card.

The electric vehicle charging and parking meter system structure 310 includes an overload detector for sensing charging circuit overloads, an open circuit detector for sensing an open charging circuit, a kilowatt transducer for determining energy used in charging of the electric vehicle, and a time clock for aiding in the determination of the energy used in charging the vehicle, and in determination of the time of parking the vehicle. A power breaker is provided for connecting and disconnecting the power to the electric vehicle being charged. The breaker is activated or deactivated by customer request or a system fault.

A series of charging and parking meters 312 can be connected to a single microprocessor unit, which unit could be contained in one of the charging and parking meter enclosures to serve more than one charging and parking meter, or could be located in a nearby protected area to serve a group of charging and parking meters.

The charging and parking meters 312 may be made to service, one, two or more electric automobiles. The charging and parking meters would function as a means of charging electric batteries when the owners are away from their residence. It is therefore hypothesized that the charging and parking meters would be located at shopping centers, indoor and outdoor theaters, parking garages, on-street and off-street parking spaces, or any other location where an electric vehicle owner may park for an extended time. Thus, the range of an electric vehicle can be extended considerably.

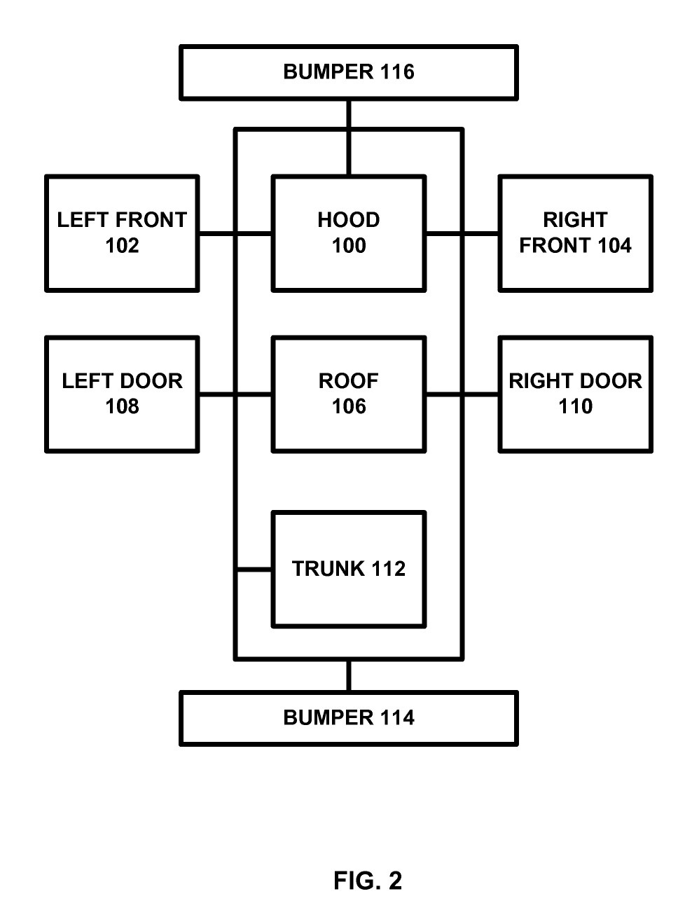

FIG. 2 illustrates an exemplary battery and power cable system for a car that can be plugged into the recharging station of FIGS. 1A-1D. In FIG. 2 each car body part is a battery shaped to provide a particular mechanical function. The battery can be a rechargeable battery such as a lithium type battery, among others. For example, a battery shaped as hood 100 covers the engine and can be opened to allow access to the engine and other drive train components. A battery shaped left and right front portions 102, 104 covers the left and right front part of the car, while a front battery shaped bumper 116 provides protection against frontal collision. A battery shaped as a left door 108 and as a right door 110 allows passenger access to the vehicle, while a battery shaped as a roof 106 protects the occupant from sun or rain. A battery shaped as a trunk 112 covers a storage space, and a battery shaped as a bumper 114 protects the vehicle from a rear collision.

The battery can be rechargeable lithium ion, although other chemistries can be used. In one embodiment, conformal batteries such as lithium polymer batteries can be formed to fit the available space of the car body part regardless of the geometry of the part. Alternatively, for batteries that are available only in relatively standard prismatic shapes, the prismatic battery can be efficiently constructed to fill the space available, be it rectilinear or irregular (polyhedral) in shape. This conformal space-filling shape applies in all three dimensions. In one embodiment, this is done by selecting a slab of lithium polymer battery material of a desired height; freezing the slab; vertically cutting the slab to a desired shape thus forming a cut edge; attaching an anode lead to each anode conductor of the cut slab along the cut edge while maintaining the cut slab frozen; and attaching a cathode lead to a each cathode conductor of the cut slab along the cut edge while maintaining the cut slab frozen. The slab may contain one or many cells. The leads may be made of single or multistranded, metallic wire, metallic ribbon, low melting point alloy, self-healing metal, and litz wire. Attachment is accomplished so as to minimize tension on the leads. The cut slab may need to be deburred after cutting and before attaching leads. The cut edge may be inspected for burrs before deburring is performed. As discussed in US Application Serial 20070079500, the content of which is incorporated by reference, burr formation can be avoided by recessing the edge of each anodic half cell or each cathodic half cell by mechanical means, blowing away dust; and insulating the recessed edges with non-conductive polymer. Lead attachment my be accomplished by a number of methods including: wire bonding; wedge bonding; adhering the lead to the electrode with conductive epoxy, anistotropic conductive adhesive or conductive thermoplastic; stapling with microstaples; adhering the lead to the electrode by electropolymerization; welding the lead to the electrode with micro welding; and growing a lead in place by electroless plating, electro-plating or a combination of electroless plating and electroplating. The leads should be insulated. Preferably the insulation is thermoplastic. If there is more than one cell in the slab, the distal ends of the leads may be connected together so that the cells are connected together in series, in parallel or some in series and the remainder in parallel. After the leads have been attached to the cut slab and connected together, the assembly will preferably be wrapped with standard packaging for lithium polymer batteries or a shrinkable form fitting version thereof.

Because the starting material for the conformal battery is purchased pre-made from a battery manufacturer, this approach eliminates the considerable expense of formulating and producing the materials for the anodes and cathodes as well as combining the anodes and cathodes into battery cells. This reduces cost and weight for the car.

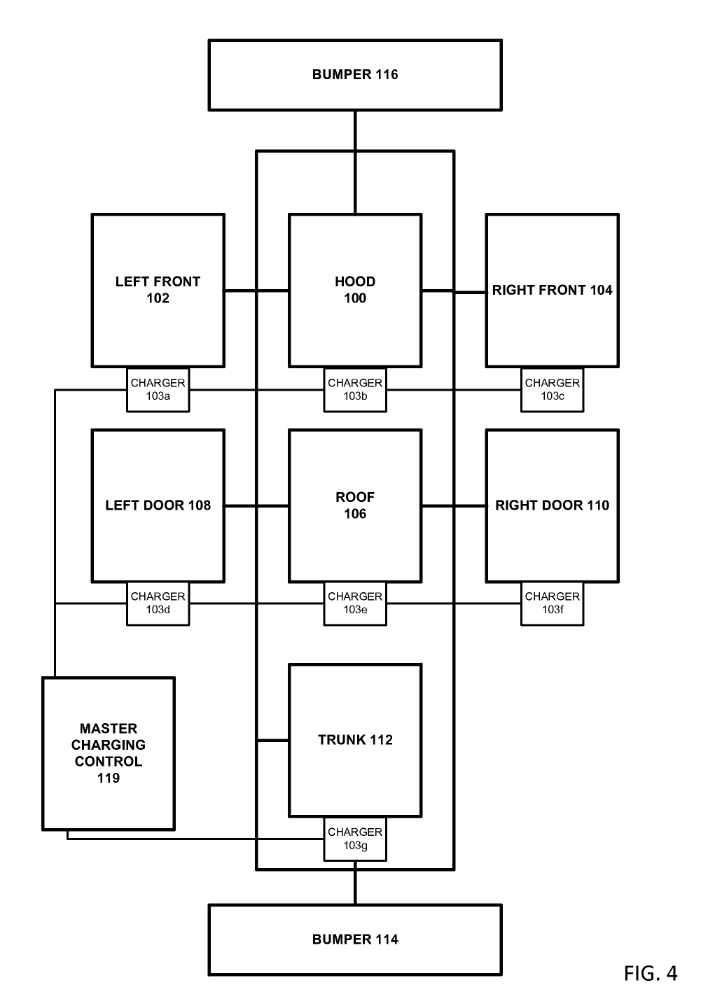

In one embodiment shown in FIG. 4, each of batteries 100-116 has a built in charger (103a-103g) and a switch to isolate each battery to enable rapid parallel charging from one power cable. During such parallel charging, each battery is charged independent of the others. A master charging controller 119 controls and coordinates the chargers 103a-103g to ensure quick charging. Battery-monitoring systems can monitor the battery's state of charge, which in turn determines the battery's cost and performance. By knowing the battery's state of charge, the system can use more capacity from each cell, use fewer cells, and maximize the lifetimes of those cells. Voltage, current, charge, temperature can provide a good indication of the state of charge. The charging/discharging of series-connected cells must stop when any cell reaches its maximum or minimum allowable state of charge. The system keeps the capacity levels the same in all cells over time and helps them age in unison. The battery-monitoring system can tweak the charge level in each cell to derive more energy and greater lifetime from the pack. Cell balancing is a critical feature in EVs and HEVs.

In one embodiment, a passive-balancing technique places a bleed resistor across a cell when its state of charge exceeds that of its neighbors. Passive balancing doesn't increase the drive distance after a charge because the technique dissipates, rather than redistributes, power. In another embodiment, active balancing is used so that charge shuttles between cells and does not end up as wasted heat. This approach requires a storage element such as capacitors, inductors, or transformers for the charge transfer. The capacitor continuously switches between two adjacent cells. Current flows to equalize the voltage and, therefore, the state of charge of the two cells. Using a bank of switches and capacitors, the voltage of all cells tends to equalize. The circuit continuously balances cells in the background as long as the switching clock is active. A transformer-based scheme transfers charge between a single cell and a group of cells. The scheme requires state-of-charge information to select the cell for charging and discharging to and from the group of six cells.

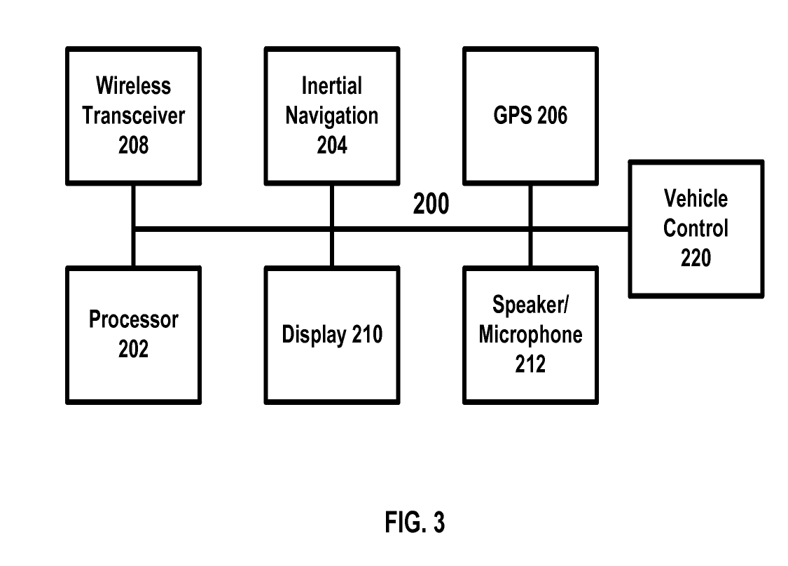

FIG. 3 shows a block diagram of an embodiment of an electrical power and automobile control system. The system is controlled by a processor 202. The processor 202 is connected with an inertial system (INS) 204 and a global positioning system (GPS) receiver 206 that generate navigation information. The processor 202 is also connected with a wireless communication device 208 that transmits and receives digital data as well as being a Doppler radar when desired. The processor 202 drives a display 210 and a speaker 212 for alerting a driver. The processor 202 provides control inputs to the automobile's braking and steering systems 220. A power cable 200 carries power between the batteries 100-116 and an electric motor engine (not shown). The power cable 200 also carries power to recharge the batteries 100-116 serially or in parallel as discussed above.

The power cable 200 can be a coaxial cable or a power cable and a data cable. In one embodiment, the same wire carrying power also carries data. Data in the form of radio frequency (RF) energy can be bundled on the same line that carries electrical current. Since RF and electricity vibrate on different frequencies, there is no interference between the two. As such, data packets transmitted over RF frequencies are not overwhelmed or lost because of electrical current. Eventually, the data can be provided to wireless transmitters that will wirelessly receive the signal and send the data on to computer stations. Exemplary protocols that can be used include CAN-bus, LIN-bus over power line (DC-LIN), and LonWorks power line based control. In one embodiment, the protocol is compatible with the HomePlug specifications for home networking technology that connects devices to each other through the power lines in a home. Many devices have HomePlug built in and to connect them to a network all one has to do is to plug the device into the wall in a home with other HomePlug devices. In this way, when the vehicle is recharged by plugging the home power line to the vehicle connectors, automotive data is automatically synchronized with a computer in the home or office.

Alternatively, two separate transmission media can be used: one to carry power and a second to carry data. In one embodiment, the data cable can be a fiber optic cable while the power cable can be copper cable or even copper coated with silver or gold. The data cable can also be an Ethernet cable. The data can be an Internet Protocol (IP) in the cable. Each body panel can have a battery recharger. The body panel can be made of lithium ion batteries. The batteries can have a shape that conforms to a specific shape such as a door or a hood or a seat, for example. To protect the occupant, a beam can be used that transfers a crash load into the vehicle body and away from a passenger cabin. Additionally, driver and passenger air bags positioned in the vehicle body. A wireless transceiver can be connected to the power cable. The wireless transceiver sends status of components in the vehicle to a remote computer. The wireless transceiver communicates maintenance information to a remote computer. If needed, the remote computer orders a repair part based on the maintenance information and schedules a visit to a repair facility to install the repair part.

This embodiment includes navigation systems, the INS 204 and the GPS receiver 206. Alternate embodiments may feature an integrated GPS and INS navigation system or other navigation system. The use of only an INS 204 or only a GPS receiver 206 as the sole source of navigation information is also contemplated. Alternatively, the wireless communication device 208 can triangulate with two other fixed wireless devices to generate navigation information.

A display 210 and speaker/microphone 212 provide both visual and audio situational awareness information to a driver. Alternate embodiments may feature only a display 210 or only a speaker 212 as the sole source of information for the driver. Embodiments that interact directly with the braking and steering systems that provide no audio information to the driver are also contemplated.

The INS 204 supplies the processor 202 with navigation information derived from accelerometers and angular position or angular rate sensors. The processor 202 may also provide the INS 204 with initial position data or periodic position updates that allow the INS 204 to correct drift errors, misalignment errors or other errors.

The INS 204 may be a standard gimbal or strapdown INS having one or more gyroscopes and substantially orthogonally mounted accelerometers. Alternatively, the INS 204 may have accelerometers and microelectromechanical systems (MEMS) that estimate angular position or angular rates. An INS 204 having a gyroscope for detecting automobile heading and a speed sensor is also contemplated.

The GPS receiver 206 supplies the processor 202 with navigation information derived from timing signal received from the GPS satellite constellation. The processor 202 may provide the GPS receiver 206 with position data to allow the GPS receiver 206 to quickly reacquire the timing signals if the timing signals are temporarily unavailable. GPS timing signal may be unavailable for a variety of reasons, for example, antenna shadowing as a result of driving through a tunnel or an indoor parking garage. The GPS receiver 206 may also have a radio receiver for receiving differential corrections that make the GPS navigation information even more accurate.

The INS 204 and the GPS receiver 206 are complementary navigation systems. The INS 204 is very responsive to changes in the trajectory of the automobile. A steering or braking input is sensed very quickly at the accelerometers and the angular position sensors. INS 204 position and velocity estimates, however, are derived by integrating accelerometer measurements and errors in the estimates accumulate over time. The GPS receiver 206 is not generally as responsive to changes in automobile trajectory but continually estimates position very accurately. The use of both the INS 204 and the GPS receiver 206 allows the processor 202 to estimate the automobile's state more accurately than with a single navigation system.

The wireless communication device 208 receives the automobile's navigated state vector from the processor 202. The wireless communication device 208 device broadcasts this state vector for use by neighboring automobiles. The wireless communication device 208 also receives the state vectors from neighboring automobiles. The received state vectors from the neighboring automobiles are sent to the processor 202 for further processing. The automobile state vector may have more or less elements describing the state of the vehicle such as the XYZ position and 3D velocity of the vehicle and 3D acceleration. Other information may be provided. For example the state vector may contain entries that describe the angular position, the angular rates, and the angular accelerations. The state vector may be described using any coordinate system or any type of units. The state vector may also contain information about the vehicle such as its weight, stopping distance, its size, its fuel state etc. Information packed in the state vector may be of value in collision avoidance trajectory analysis or may be useful for generating and displaying more accurate display symbology for the driver. For example, the automobile may receive a state vector from a neighboring vehicle that identifies the vehicle as an eighteen wheel truck with a ten ton load. Such information may be important for trajectory analysis and for providing accurate and informative display symbology.

The wireless communication device 208 may be part of a local area wireless network such as an IEEE 802.11 network. The local area network may be a mesh network, ad-hoc network, contention access network or any other type of network. The use of a device that is mesh network enabled according to a widely accepted standard such as 802.11(s) may be a good choice for a wireless communication device 208. The wireless communication device 208 may also feature a transmitter with low broadcast power to allow automobiles in the area to receive the broadcast signal. The broadcast of state vectors over a broad area network or the internet is also contemplated.

The display 210 and the speaker 212 are features that provide the driver with situational awareness. The processor 202 sends commands to the display 210 and the speaker 212 that alert the driver to hazards. The display 210 may for example show the relative positions and velocities of neighboring vehicles. The display 210 may also warn the driver to slow down or apply the brakes immediately. The speaker 212 may give aural warnings such as “STOP” or “CAUTION VEHICLE APPROACHING”.

The braking and steering systems 220 may also be commanded by the processor 202. The processor 202 may command that the brakes be applied to prevent collision with a vehicle ahead or may provide a steering input to prevent the driver from colliding with a vehicle. The processor 202 may also issue braking or steering commands to minimize the damage resulting from a collision as discussed in United States Patent Application 20080091352, the content of which is incorporated by reference.

It should be understood, of course, that the foregoing relates to exemplary embodiments of the invention and that modifications may be made without departing from the spirit and scope of the invention as set forth in the following claims.

What is claimed is:

1. An electric vehicle charging station, comprising:
a. a parking meter;
b. a main display coupled to the parking meter to display information;
c. a fast charge port and a regular charge port coupled to the parking meter to dispense electricity upon authorization;
d. a payment reader coupled to the parking meter to accept a financial card and to enable one or more ports after card authorization;
e. a door coupled to the charge ports, the door allowing access to the ports after authorization and closing access to the ports after charging completes, the door securing the port from unauthorized charging and to secure the ports from tampering; and
f. an outer casing to enclose the parking meter.

2. The charging station of claim 1, wherein the information includes advertisements.

3. The charging station of claim 1, wherein the parking meter accepts pre-paid cards.

4. The charging station of claim 1, wherein the main display comprises a touch screen.

5. The charging station of claim 1, wherein the regular charge port comprises a 110V port.

6. The charging station of claim 1, wherein the fast charge port comprises a high voltage at or above 220V.

7. The charging station of claim 1, comprising a recharger coupled to a plurality of vehicles with full reporting of power consumed and duration of charge cycle.

8. The charging station of claim 7, wherein the charger is fully weatherized and certified under UL291 for outdoor use with SAE J1772 connectivity.

9. The charging station of claim 1, comprising a utility grade electronic meter

10. The charging station of claim 1, wherein the payment reader accepts a smart card, a credit card, paper money, code through a key card, or a biometric thumb print.

11. The charging station of claim 1, wherein the payment reader accepts a pay point system.

12. The charging station of claim 1, comprising a screen coupled to the parking meter to display advertisement.

13. The charging station of claim 12, wherein the ports provide power when one or more advertisements are shown.

14. The charging station of claim 1, comprising a wireless transmitter to provide charging information over a wireless network.

15. The charging station of claim 14, wherein the wireless network comprises a cellular telephone network.

16. The charging station of claim 1, comprising an anti-power piracy and security circuit.

17. The charging station of claim 1, comprising a sensor to detect if a power cable has been cut, wherein the power is shut off and a text message is sent to a vehicle owner and to a utility to inform about power interruption.

18. The charging station of claim 1, comprising a tamper alarm to generate an alarm sound if system security is violated.

19. The charging station of claim 1, comprising a smart controller to optimize a charging schedule to minimize cost, enhance grid stability, and to safely set maximum battery charge rate within the electrical limits of the battery, battery charger, and premises/charging station.

20. The charging station of claim 1, wherein the smart controller communicates through one of: RS-232, SPI, I2C, ZigBee, and CAN 2.0 methods.
